(19) United States
(12) Patent Application Publication
(10) Pub. No.: US 2002/0152292 A1
(43) Pub. Date: Oct. 17, 2002

(54) Method and system of remote support of device using e-mail

(75) Inventors: Tetsuro Motoyama, Cupertino, CA (US); Avery Fong, Castro Valley, CA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Ricoh Company Limited, Tokyo (JP)

(21) Appl. No.: 09/756,120

(22) Filed: Jan. 9, 2001

(51) Int. Cl. G06F 15/173

(52) U.S. Cl. 709/223

(57) ABSTRACT

A computer-implemented system, method, and computer program product for remotely monitoring network devices. A network management protocol such as the simple network management protocol (SNMP) is used to collect status information and/or configuration information from devices connected to a network such as an intranet. The information collected may be stored on a database connected to that network. The information is sent via a standard communication technique, such as e-mail to a remote monitor. The remote monitor retrieves the information from, for example, a mail server and stores the device information in a database connected to the network of the remote monitor.

### CROSS REFERENCE TO RELATED APPLICATIONS

The present application, attorney docket number 198775US-5244-5244-2, is related to the following U.S. applications and Pat. Nos.: 09/668,162 filed Sep. 25, 2000; 09/575,710 filed Jul. 25, 2000; 09/575,702 filed Jul. 12, 2000; 09/453,934 filed May 17, 2000; 09/453,935 filed May 17, 2000; 09/453,936 filed May 17, 2000; 09/453,937 filed May 17, 2000; 09/542,284 filed Apr. 4, 2000; 09/520,368 filed Mar. 7, 2000; 09/440,692 filed Nov. 16, 1999; 09/440,647 filed Nov. 16, 1999; 09/440,646 filed Nov. 16, 1999; 09/440, 693 filed Nov. 16, 1999; 09/440, 645 filed Nov. 16, 1999; 09/408,443 filed Sep. 29, 1999; 09/407,769 filed Sep. 29, 1999; 09/393,677 filed Sep. 1 0, 1999; 09/311,148 file d May 13, 1999 ; 09 /192,583 filed Nov. 17, 199 8; 09/190,460 filed Nov. 13, 1998; 08/883,492 filed Jun. 26, 1997; 09/108,705 filed Jul. 1, 1998; 09/107,989 filed Jul. 1, 1998; 08/997,705 filed Dec. 23, 1997; 08/738,659 filed Oct. 30, 1996; 08/738,461 filed Oct. 30, 1996; 09/457,669 filed Dec. 9, 1999; 08/916,009 filed Aug. 21, 1997; 07/902,462 filed Jun. 19, 1992; 07/549,278 filed Jul. 6, 1990; 6,085,196; 5,909,493; 5,887,216; 5,818,603; 5,819,110; 5,774,678; 5,649,120; 5,568,618; 5,544,289; 5,537,554; and 5,412,779. The entire contents of each of those applications and patents are incorporated herein by reference.

### BACKGROUND OF THE INVENTION

1. Field of the Invention

This invention relates to a method and system that can collect status data from networked devices residing on various networks and send the collected status data via e-mail to a remote monitoring device.

2. Discussion of the Background

The Simple Network Management Protocol (SNMP) was developed to provide a simple and standard method for accessing networked devices on an Internet Protocol (IP) network, where those devices may be from a variety of manufacturers. The SNMP is described in RFC 1157, “A Simple Network Management Protocol (SNMP),” available from the Internet Engineering Task Force (IETF) at http://www.IETF.org/rfc.html, the entire contents of which is incorporated herein by reference. SNMP enables network managers to assess the status of devices residing on their network. However, SNMP does not, by itself, provide an approach for remotely monitoring devices residing on multiple networks from a central location.

SNMP was developed for use on networks based on the Transmission Control Protocol/Internet Protocol (TCP/IP). TCP/IP and related protocols are described in several references, including (1) TCP/IP Illustrated, Vol. 1, The Protocols, by Stevens, from Addison-Wesley Publishing Company, 1994, ISBN: 0201633469; (2) Internetworking with TCP/IP by Comer and Stevens, 4th edition, Vol. 1 (Apr. 15, 2000), Prentice Hall; ISBN: 0130183806; (3) Internetworking with TCP/IP, Vol. II, ANSI C Version: Design, Implementation, and Internals, by Comer and Stevens, 3 edition (Jun. 10, 1998) Prentice Hall; ISBN: 0139738436; (4) Internetworking with TCP/IP, Vol. 111, Client-Server Programming and Applications-Windows Sockets Version, by Comer and Stevens, 1 edition (Apr. 28, 1997) Prentice Hall; ISBN: 0138487146; and (5) TCP/IP Clearly Explained, by Loshin, ₃rd Edition (1999) Academic Press, ISBN: 0-12-455826-7. The contents of all five books are incorporated herein by reference in their entirety.

Ricoh Company, Ltd., has developed a system called CSS that uses telephone lines to monitor copiers in the field. However, a problem with the CSS system is that it requires a large number of operators requiring monitors and a large number of modems and modems ports, each of which increases as the number of devices being monitored increases. Therefore, the cost of operating the CSS system increases rapidly as the number of supported devices increases.

### SUMMARY OF THE INVENTION

The present inventors have recognized a need for remotely monitoring a large number of devices residing on multiple networks from a centralized location, without the need for adding additional resources, both human and hardware, as the number of supported devices increases. There is also a need, as recognized by the present inventors, for remotely monitoring devices on networks located in various geographic locations, where the devices on those networks may have been made by a variety of manufacturers.

Accordingly, one object of the present invention is to provide a system and method for remotely monitoring devices on a variety of networks using a standard network management protocol and a standard means for communicating that status information to a centralized location. By using a standard network management protocol, devices compliant with that standard, from a variety of manufacturers, may be monitored by a single system. Furthermore, by using a standard communication mechanism, a variety of networks in various geographic locations may easily communicate information pertaining to the status of devices on those networks to a centralized location.

The present invention achieves these and other objects by using a standard network management protocol for monitoring the status of devices on one or more networks, and then reporting that status information using a standard communication approach to a remote monitoring system. In one embodiment, the device status information is determined by a network monitor workstation using the simple network management protocol (SNMP). The device status information is stored locally in a repository, such as a database accessible to the network monitor workstation. At predetermined intervals, or in response to predetermined events, the device status information is sent via e-mail to the remote monitor. The remote monitor receives network status information from multiple networks, each of these networks containing devices that may be made by a variety of manufacturers. At predetermined intervals, or in response to predetermined events, the remote monitor workstation retrieves its e-mail from a mail server, the e-mail will include the device status information from networks being monitored.

One advantage of the present invention is that as the number of devices being monitored increases, it is not necessary to add additional hardware or human resources in order to monitor those newly added devices. Furthermore, by using standard software, such as SNMP and e-mail, the expense and complexity of providing a remote monitoring service is greatly reduced.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a block diagram of an overall system configuration for one embodiment of the present invention;

FIG. 2 is a block diagram showing the various mechanisms on the sending side and the receiving side of a system according to one embodiment of the present invention;

FIG. 3 is a block diagram showing the various interactions among the mechanisms on the sending side and the receiving side of a system according to one embodiment of the present invention;

FIG. 4 is a flow diagram illustrating the flow of the task driver mechanism on the sending side of a system according to one embodiment of the present invention;

FIG. 5 is a flow diagram illustrating the flow of the device information manager mechanism on the sending side of a system for sending device configuration information according to one embodiment of the present invention;

FIG. 6 is a flow diagram illustrating the flow of the monitor mechanism on the sending side of a system according to one embodiment of the present invention;

FIG. 7 is a flow diagram illustrating the flow of the sender mechanism on the sending side of a system according to one embodiment of the present invention;

FIG. 8 is a flow diagram illustrating the flow of the task driver mechanism on the receiving side of a system according to one embodiment of the present invention;

FIG. 9 is a flow diagram illustrating the flow of the receiver mechanism on the receiving side of a system according to one embodiment of the present invention;

FIG. 10 illustrates an exemplary structure of data providing device information that is stored in a database of a system according to one embodiment of the present invention;

FIG. 11 illustrates an exemplary structure of data providing device status information that is stored in a database of a system according to one embodiment of the present invention;

FIG. 12 illustrates the elements of an exemplary computer system programmed to perform one or more of the special purpose functions of the present invention;

FIG. 13 is a block diagram of a system according to one exemplary implementation of the present invention;

FIG. 14 illustrates the interactions among the major packages according to one exemplary implementation of the present invention;

FIG. 15 illustrates the Monitor_Send DLL package according to one exemplary implementation of the present invention; and

FIG. 16 illustrates the Receive_Store DLL package according to one exemplary implementation of the present invention;

### DETAILED DESCRIPTION OF THE PREFERRED EMBODIMENTS

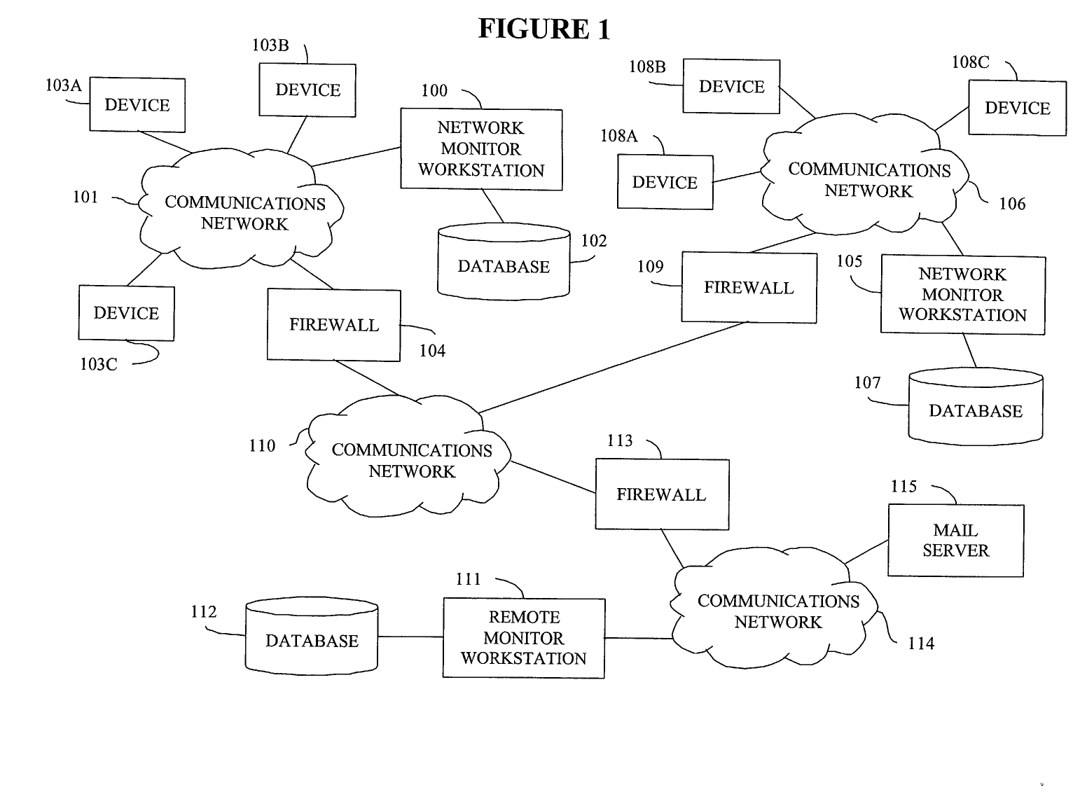

Referring now to the drawings, wherein like reference numerals designate identical or corresponding parts throughout the several views, and more particularly to FIG. 1 thereof, which is a block diagram of a system for monitoring device status of devices residing on multiple networks from a remote system via e-mail. The system includes a remote monitor workstation 111 and a database 112. The remote monitor workstation 111 can access e-mail from a mail server 115 through a communications network 114. The communications network 114 is protected from the communications network 110 by a firewall 113. The communications network 114 represents a network from which remote monitoring of devices on various networks is performed. FIG. 1 shows a system where devices residing on two separate communications networks 101, 106 are monitored. The configuration shown in FIG. 1 is an exemplary configuration only, the present invention not being limited to a particular configuration. In the exemplary configuration of FIG. 1, the communications network 114 represents a network, for example, an intranet, from which the remote monitoring is performed. The communications networks 101 and 106 represent networks having devices that will be monitored by the remote monitor workstation 111. The communications networks 101 and 106 may be, for example, intranets belonging to the same or different companies, and may be co-located or located at different geographic locations. The communications networks 101, 106 to be monitored are accessible from the communications network 114 via another communications network 110. In one embodiment of the present invention, the communications network 110 is the Internet.

The present invention will be described in the context of a single communications network 101 being monitored by a remote monitor workstation 111. However, as discussed above, this is a simplification of the present invention for explanation purposes only. As would be understood by one of ordinary skill in the network computing or software art, a variety of configurations can be supported by the present invention.

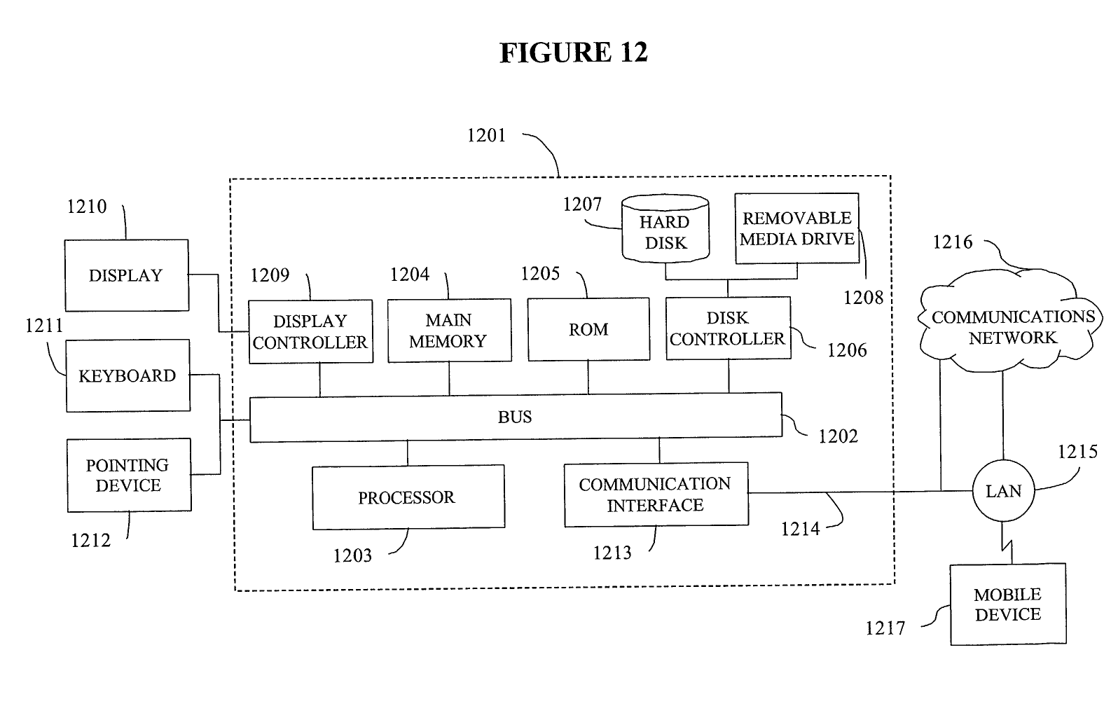

The communications network 101 has connected thereto several devices 103A, 103B, and 103C to be monitored remotely. The devices 103 may be any network device capable of providing device status information (e.g., compliant with a network management protocol, such as, for example, SNMP) to a network monitor workstation 100, also connected to the communications network 101. The network monitor workstation 100 is implemented using the computer system 1201 of FIG. 12, for example, but also may be any other suitable personal computer (PC), workstation, server, or device for gathering device status information from devices 103 connected to a communications network 101, storing and retrieving information from a database 102, and communicating via a standard communication technique over the communications network 110.

The database 102 is a digital repository that may be implemented, for example, through a commercially available relational database management system (RDBMS) based on the structured queried language (SQL) such as, for example, ORACLE, SYBASE, INFORMIX, DB/2, MICROSOFT ACCESS, or MICROSOFT SQL SERVER, through an object-oriented database management system (ODBMS), or through custom database management software. In one embodiment, the database 102 contains information describing the devices 103 on the communications network 101 that are monitored. For example, the database 102 contains descriptive information pertaining to each device 103, such as, for example, information descriptive of the device 103 itself, network address information, information as to the physical location of the device 103, contact information identifying an individual responsible for the device 103, and status information.

Data in the database 102 is maintained by processes running on the network monitor workstation 100. The database 102 may reside on a storage device of the network monitor workstation 100, or reside on another device connected to the network monitor workstation 100, for example, by way of a local area network, or other communications link such as a virtual private network, wireless link, or Internet-enabled link. In one embodiment of the present invention, the communications network 101 is implemented as an intranet protected by a firewall 104.

A firewall 104 is connected between the communications network 101 and the communications network 110. The firewall 104 is a device that allows only authorized computers on one side of the firewall to access a network or other computers on the other side of the firewall. Firewalls such as firewall 104, 109, and 113 are known in commercially available devices and/or software and, for example include SunScreen from Sun Microsystems, Inc. Firewalls are discussed in detail in Cheswick, W. R., and Bellovin, S. M., “Firewalls and Internet Security,” Addison-Wesley Publishing, 1994; and Chapman, D.B., and Zwicky, E. D., “Building Internet Firewalls,” O'Reilly and Associates, Inc., 1995, the entire contents of both of which are incorporated herein by reference.

The network monitor workstation 100 uses a standard network management protocol to query for status from the monitored devices 103 residing on the communications network 101. In one embodiment, the network monitor workstation 100 uses the Simple Network Management Protocol (SNMP) to exchange information with the various devices 103. The SNMP accesses information stored on the device 103. In one embodiment, each device includes one or more pieces of information defined by various Management Information Bases (MIB) (e.g., those defined by RFCs 1514 and 1750 discussed below). The information maintained in the MIBs can be queried or manipulated via SNMP-compliant calls specifying a particular device. In some cases, a private MIB is created to provide enhanced capabilities over the standard MIBs. The MIB is a part of the TCP/IP suite for managing network elements. The MIB is described in detail in (1) RFC 1212, “Concise MIB Definition”; (2) RFC 1213, “Management Information Base for Network Management of TCP/IP-based internets: MIB-II”; (3) RFC 1514, “Host Resources MIB”; and (4) RFC 1750, “Printer MIB,” all four of which are available from the Internet Engineering Task Force (IETF) at http://www.IETF.org/rfc.htrnl, the entire contents of all four being incorporated herein by reference.

The status information received from the devices 103 via the communications network 101 is stored by the network monitor workstation 100 in the database 102. On a periodic basis, or in response to predetermined events, the various network monitor workstations 100, 105 communicate the status of the devices 103, 108 for which they are responsible for monitoring, to the remote monitor workstation 111 via the communications network 110 using a standard communication technique.

In one embodiment of the present invention, the device status information collected using SNMP calls to query the MIB of the monitored devices 103, is sent by the network monitor workstation 100 via the Internet using standard e-mail. E-mail over the Internet is described in Gralla, P., “How the Internet Works,” Millennium Edition (Aug. 1999), Que, ISBN: 0-7897-2132-5, the entire contents of which is incorporated herein by reference. E-mail over the Internet uses the Simple Mail Transfer Protocol (SMTP) to send and receive messages. The SMTP is described in RFC 821, “Simple Mail Transfer Protocol (SMTP),” available from the Internet Engineering Task Force (IETF) at http://www.IETF.org/rfc.html, the entire contents of which is incorporated herein by reference. Other Internet e-mail-related RFCs are (1) RFC 822, “Standard for the Format of ARPA Internet Text Message”; (2) RFC 2045, “Multipurpose Internet Mail Extensions (MIME), Part One: Format of Internet Message Bodies”; (3) RFC 1894, “An Extensible Message Format for Delivery Status Notifications”; and (4) RFC 2298, “An Extensible Message Format for Message Disposition Notifications,” all four of which are available from the Internet Engineering Task Force (IETF) at http://www.IETF.org/rfc.html, the entire contents of all four being incorporated herein by reference.

E-mails sent from the network monitor workstations 100, 105 via the communications network 110 are received by the communications network 114 through a firewall 113. The e-mails are stored in a mail server 115. In one embodiment, the mail server 115 supports the Post Office Protocol, version 3 (POP 3). The POP3 protocol is an Internet standard which is described in detail in RFC 1939, “Post Office Protocol-version 3,” available from the Internet Engineering Taskforce (IETF) at http://www.ietf.org/rfc.html, the entire contents of which is incorporated herein by reference. On a periodic basis, or in response to a predetermined event, the remote monitor workstation 111 retrieves its mail via the communications network 114 from the mail server 115.

In another embodiment of the present invention, the mail server 115 supports the Internet Mail Access Protocol (IMAP). The IMAP protocol is another TCP/IP protocol which is described in detail in RFC 2060, “Internet Message Access Protocol—Version 4rev1,” available from the Internet Engineering Taskforce (IETF) at http://www.ietf.org/rfc.html, the entire contents of which is incorporated herein by reference.

The remote monitor workstation 111 may be implemented using the computer system 1201 of FIG. 12, for example, or any other suitable PC, workstation, server, or device for receiving e-mail messages via the communications network 114 from the mail server 115, and storing and retrieving information in the database 112. The remote monitor workstation 111 is used to process the incoming e-mails from the different SNMP monitoring workstations at different locations, or for different Intranets, for example.

The database 112 is a digital repository that may be implemented, for example, through one or more of the commercially available RDBMs based on SQL, through an ODBMS, or through custom database management software. In one embodiment, the database 112 stores the descriptive information and status history for the devices 103, 108 being monitored. In one embodiment, the database 112 also stores various information such as the nearest dealership, warranty information, and aggregated model information relating to the devices 103, 108 being monitored. The database 112 may reside on a storage device of the remote monitor workstation 111, or reside on another device connected to the remote monitor workstation 111, for example, by way of a local area network or other communications links such as a virtual private network, wireless link, or Internet-enabled link. The remote monitor workstation 111 is capable of communicating to the various network monitor workstations 100, 105 through, for example, e-mail.

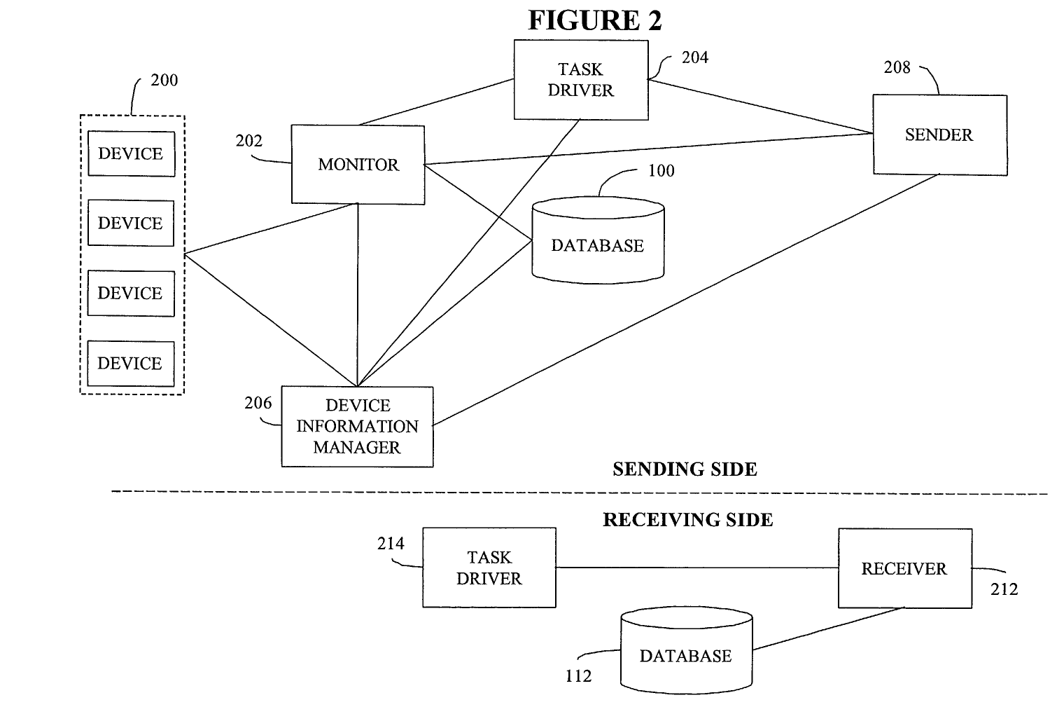

FIG. 2 describes the major modules of the system of the present invention at the sending side and receiving side. As shown in FIG. 2, the sending side includes a task driver 204, a monitor 202, a device information manager 206, and a sender 208. The task driver 204 is responsible for controlling the tasks performed by the monitor 202, the sender 208, and the device information manager 206. The monitor 202 communicates with the various devices 200 and stores status information received from the devices 200 in the database 100. The device information manager 206 is responsible for configuration information relating to the devices 200 and storing that information in database 100. The sender 208 is responsible for sending status information and configuration information via e-mail to the receiver 212 on the receiving side.

The task driver 214 on the receiving side is responsible for controlling the tasks performed by the receiver 212. The receiver 212 retrieves the e-mails sent by the sender 208 and stores the appropriate updated status information relating to the devices 200 in the database 112.

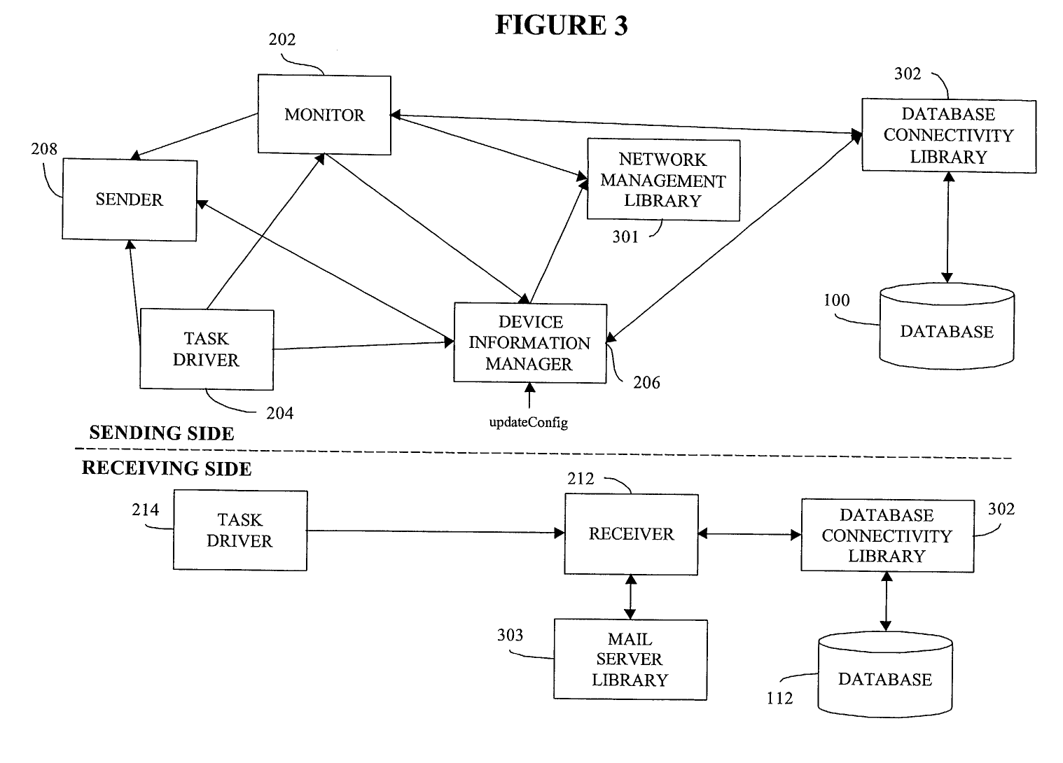

FIG. 3 describes the interaction among the various mechanisms shown in FIG. 2 in greater detail. As shown in FIG. 3, the task driver 204 on the sending side interacts with the monitor 202, the device information manager 206, and the sender 208. The task driver 204 triggers the device information manager 206 to send configuration information pertaining to the devices 103, 108 being monitored to the receiving side. The task driver 204 further triggers the monitor 202 to send network management commands, for example, SNMP commands, to obtain status information from the devices 103, 108 being monitored. The task driver 204 further triggers the sender 208 so that it may generate e-mail messages containing status information regarding the devices 103, 108 and send those e-mail messages to the receiving side.

The device information manager 206 interacts with the database 100 through a database connectivity library 302. In one embodiment, the database connectivity library 302 is a commercially available database connectivity library, for example, an open database connectivity (ODBC) library available from a variety of vendors including Microsoft Corporation. As would be understood by one of ordinary skill in the software art, an ODBC library provides routines for interacting with a database. The device information manager 206 interacts with the devices 103 being monitored through a network management library 301. In one embodiment, the network management library is an SNMP library, for example, SNMP++ DLL which is available from Hewlett Packard. As would be understood by one of ordinary skill in the software art, an SNMP library includes functions for invoking SNMP commands. The device information manager 206 interacts with the sender 208 to create and send e-mail messages containing configuration information to the receiving side.

The monitor 202 interacts with the device information manager 206, the devices 103 being monitored through the network management library 301, with the database 100 through the database connectivity library 302, and with the sender 208. The monitor 202 receives descriptive information relating to the devices 103 by making requests to the device information manager 206. The device information manager 206 retrieves the requested information from the database 100 through calls to the database connectivity library 302. The monitor queries the devices 103 for status information through calls made to the network management library 301 after receiving the descriptive information from the device information manager 206. For example, the monitor 202 will request an IP address for a particular device from the device information manager 206. The monitor 202 will then use that IP address to query the device 103 by invoking the appropriate method from the network management library 301 by providing the IP address to that method. Status information relating to the devices 103 received by the monitor 202 is stored in the database 100 through interactions with the appropriate methods of the database connectivity library 302, for example, by making the appropriate ODBC calls. The monitor 202 can cause the sender 208 to prepare and send one or more e-mail messages to the receiving side by triggering the sender 208 and providing the sender 208 with the status information relating to the devices 103 to be sent.

On the receiving side, the task driver 214 interacts with the receiver 212 to cause the receiver 212 to retrieve e-mail messages from the mail server 115. The receiver 212 interacts with the mail server 115 through the mail server library 303. In one embodiment, the mail server library is a POP 3 library that is used to connect to the mail server 115 and retrieve received e-mail messages. The receiver 212 stores information received via e-mail messages from the mail server 115 via the mail server library 303 in the database 112. As discussed above, the interactions with the database 112 are through a database connectivity library 302, for example, an ODBC library.

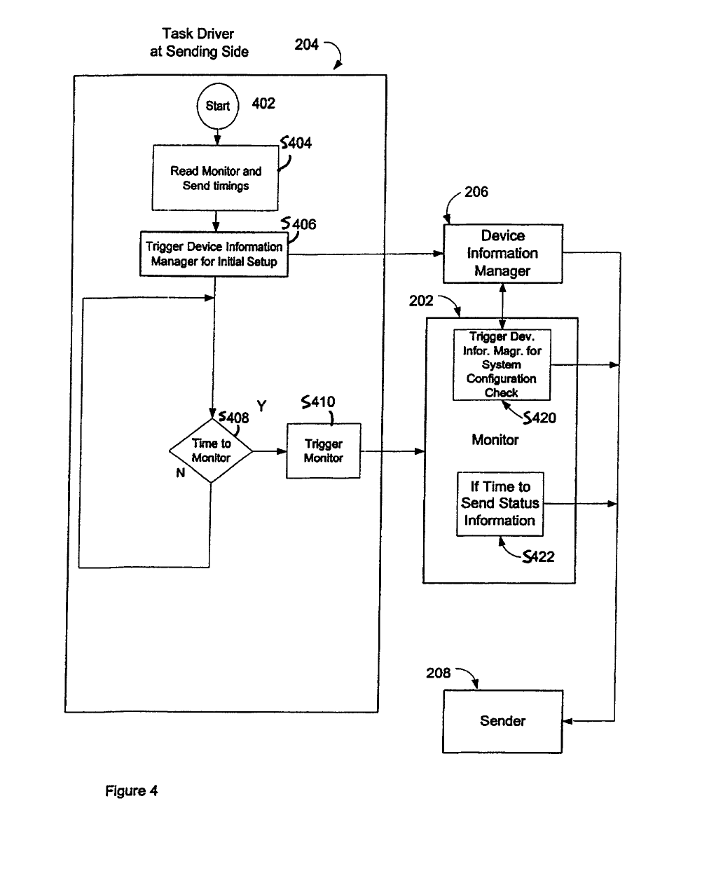

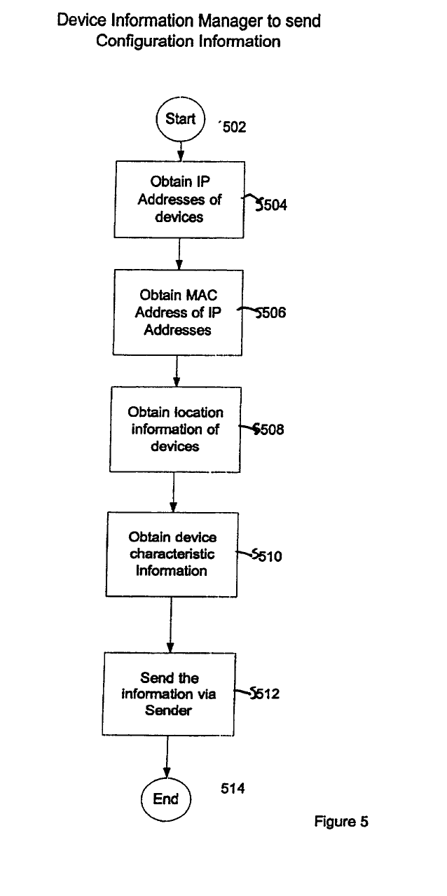

FIG. 4 illustrates the processing flow of the task driver 204 on the sending side according to one embodiment of the present invention. The process shown in FIG. 4 will begin when the system is turned on, and continuously run thereafter. In one embodiment, the task driver 204 is a process that runs on the network monitor workstation 100, 105 to monitor the devices 103, 108 residing on the communications network 101, 106 for which the network monitor workstation 100, 105 is responsible for monitoring. As shown in FIG. 4, the process begins with step S404 where the task driver 204 obtains the timing information for monitoring the devices 103, 108 and the timing information for sending the collected data to the receiving side. The process then proceeds to step S406, where the task driver 204 will trigger the device information manager 206 to perform its initial setup. The initial setup processing performed by the device information manager 206 will be described in relation to FIG. 5, below. The process then proceeds to step S408 where the task driver 204 will enter a loop which will cause the devices 103, 108 to be periodically monitored. When it is determined that it is time to monitor the devices 103, 108 (i.e., “Yes” at step S408), the process proceeds to step S410 where the monitor 202 is triggered. The monitor 202 may be triggered to cause the device information manager 206 to perform a system configuration check at step S420, or, if the predetermined time to send status information has been reached at step S422, the monitor 202 will cause the device information to be sent via the sender 208. When it is determined that it is not time to monitor the devices 103, 108 (i.e., “No” at step S408), the process will continue to loop until such a time is reached.

The present invention also includes a maintenance module (not shown in the figures) for inputting configuration data and verifying information on the network. The maintenance module may also be used to perform standard maintenance tasks on the database 100. The maintenance module provides a mechanism through which configuration changes can be made, such as adding, removing, or replacing network devices 103, 108 to be monitored. In addition, the contact person for the network devices 103, 108 may be changed through the maintenance module.

FIG. 5 is a flow diagram illustrating the processes performed by the device information manager 206 to send configuration information. As shown in FIG. 5, the process begins at step S504 where the device information manager 206 obtains Internet protocol (IP) addresses of each of the devices 103, 108 being monitored. The process then proceeds to step S506 where the device information manager 206 obtains the media access control (MAC) addresses for each of the devices 103, 108 corresponding to each of the IP addresses obtained in step S504. Where appropriate, the tasks performed by the device information manager 206 are performed via commands available in the network management library 301, for example, through SNMP commands. The process then proceeds to step S508 where location information for each of the devices 103, 108 being monitored is obtained. The process then proceeds to step S510 where characteristic information, for example, make and model, of each of the devices 103, 108 being monitored is obtained. The process then proceeds to step S512 where the configuration information is sent by the device information manager 206 to the receiving side via the sender 208. As discussed above, the information is sent using a standard communication technique, for example, via an e-mail message. The steps of the process in FIG. 5 may be performed through database connectivity library 302 calls which provide access to the database 100. If the database is local to the network monitor workstation 100 on which the device information manager 206 is being executed, each record corresponding to each device 103, 108 being monitored may be processed from start to finish until all devices 103, 108 have been processed, for example, through a looping mechanism. On the other hand, if the database 100 is remote to the network monitor workstation 100 on which the device information manager 206 is executing, the process may be modified, such that all database records are retrieved prior to beginning the processing of those records.

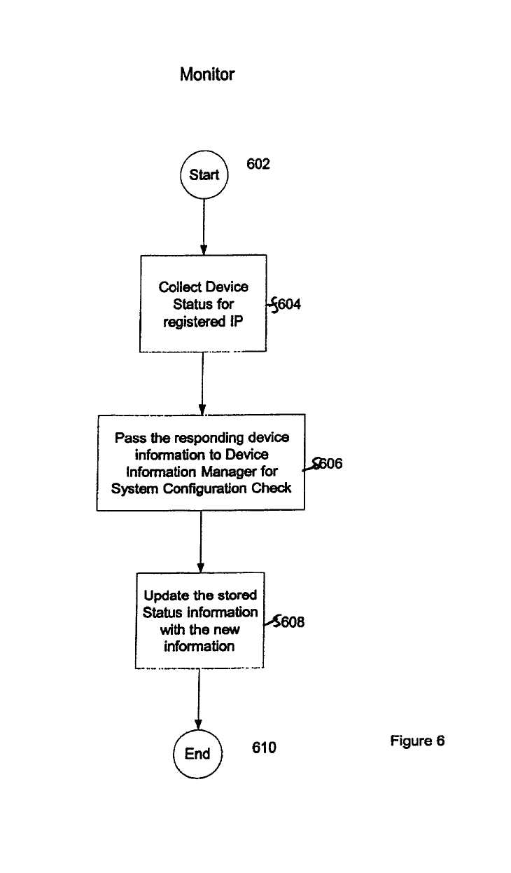

FIG. 6 is a flow diagram showing the processes performed by the monitor 202 on the sending side according to one embodiment of the present invention. As shown in FIG. 6, the process begins with step S604 where device 103, 108 statuses are updated for each registered IP address. As discussed above, the monitor 202 will query the devices 103, 108 via calls to a network management library 301, for example, via SNMP calls. The process then proceeds to step S606 where information received from each responding device 103, 108 is passed to the device information manager 206 so that a system configuration check may be performed by the device information manager 206. The process then proceeds to step S608 where updated status information corresponding to each of the devices 103, 108 being monitored is stored in the database 100 via calls to a database connectivity library 302, for example, via ODBC calls. For each IP address, additional information will be collected so that the system can verify that the device 103, 108 being queried is indeed the device which has been configured for that IP address. In one embodiment of the present invention, MAC addresses are used for uniquely identifying the devices 103, 108, thereby enabling the system to carefully track which device 103, 108 is at each IP address.

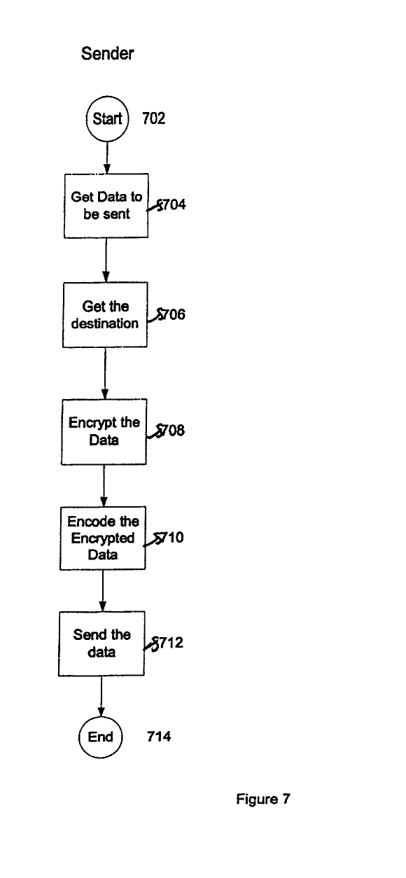

FIG. 7 is a flow diagram describing the process performed by the sender 208. As shown in FIG. 7, the process begins at step S704 where the data to be sent to the receiving side is obtained. This data is either system configuration information (e.g., the information described above in the context of step S420 of the process shown in FIG. 4) or status information (e.g., the information described above in the context of step S422 of the process shown in FIG. 4). The process then proceeds to step S706 where the destination for the data is obtained. The destination specifies where the information is to be sent. In one embodiment, the destination is sent by the task driver 204 to the sender 208 when the system is started. The process then proceeds to step S708 where the data to be sent to the destination is encrypted. The process then proceeds to step S710 where the encrypted data is encoded. The process then proceeds to step S712 where the encoded encrypted data is sent to the destination.

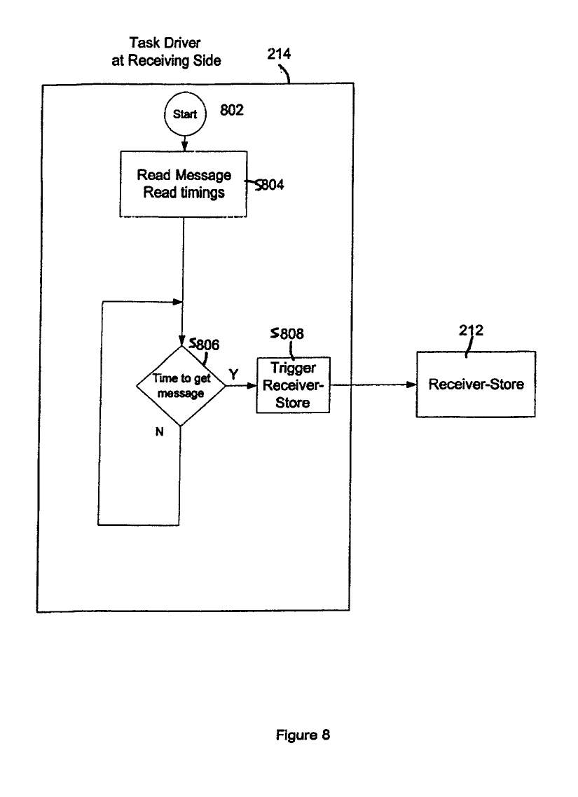

FIG. 8 is a flow diagram describing the process of the task driver 214 on the receiving side of the present invention. The task driver 214 is started when the system is initially turned on and runs continuously thereafter. As shown in FIG. 8, the process begins at step S804 where the location of the received information and account and user information are received by the receiver 212. In addition, the receiver 212 reads information pertaining to the timing of retrieving the received information. The process then proceeds to step S806, which implements a loop determining whether it is time to get a message. In one embodiment, a function call (e.g., sleep()) is used to implement the desired timing of the loop. If it is determined that is time to get a message (i.e., yes at step S806), the process proceeds to step S808 where the receiver 212 is triggered. If it is not time to get a message (i.e., no at step S806), the process loops on step S806 until it is time to get a message.

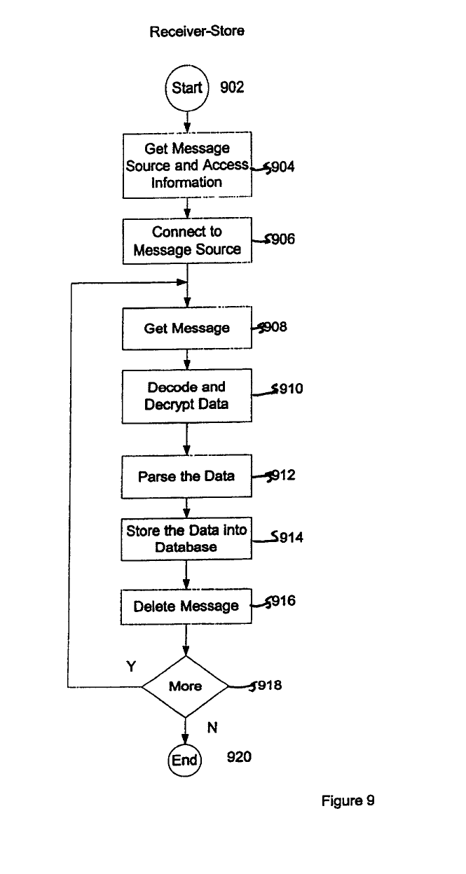

FIG. 9 is a flow diagram describing the process performed by the receiver 212. As shown in FIG. 9, the process begins at step S904 where information concerning the location of the received messages and access information for accessing new messages are obtained from, for example, the registry on the remote monitor workstation 111, or a file. In one embodiment, the location and access information include the POP 3 server name, the user name, and password required to access the received messages. The process then proceeds to step S906 where the receiver 212 connects to the mail server 115 via calls made to the mail server library 303, for example, POP 3 calls. The process then proceeds to step S908 where a message is retrieved from the mail server 115, again, via calls to the mail server library 303. The process then proceeds to step S910 where the received message is decoded and decrypted to obtain the data contained in the message. The process then proceeds to step S912 where the decoded and decrypted data is parsed into its various components. The process then proceeds to step S914 where the information parsed from the data is stored in the database 112 via calls to the database connectivity library 302, for example, via ODBC calls. The process then proceeds to step S916 where the message retrieved from the mail server 115 is deleted. The process then proceeds to step S918 which is a loop to determine if more messages have been received. If it is determined that more messages have been received (i.e., “Yes” at step S918), the process returns to step S908 where that additional message will be retrieved. If, on the other hand, it is determined that no more messages have been received (i.e., “No” at step S918), the process ends.

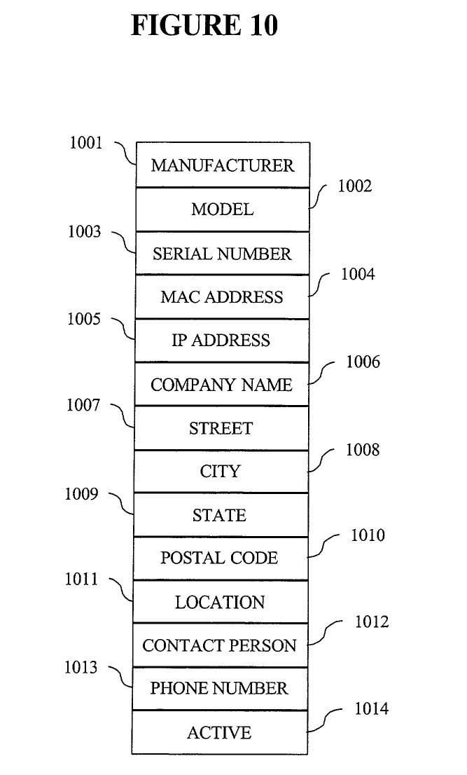

FIG. 10 is an exemplary data structure providing device information that may be stored in the databases 100, 112 in one embodiment of the present invention. As shown in FIG. 10, the data structure includes, for example, information descriptive of the devices 103, 108, such as a manufacturer field 1001 indicating the maker of the devices 103, 108, a model number field 1002, a serial number field 1003, and a MAC address field 1004. The data structure may also include an IP address field 1005 indicating the network address of the devices 103, 108, as well as physical location information indicating where the devices 103, 108 are located, such as a company name field 1006, a street address field 1007, a city field 1008, a state field 1009, a postal code field 1010, and a location field 1011 indicating, for example, the room number in which the devices 103, 108 are located. The data structure may also include other information, such as a contact person field 1012, a contact phone number field 1013, and an active indicator field 1014.

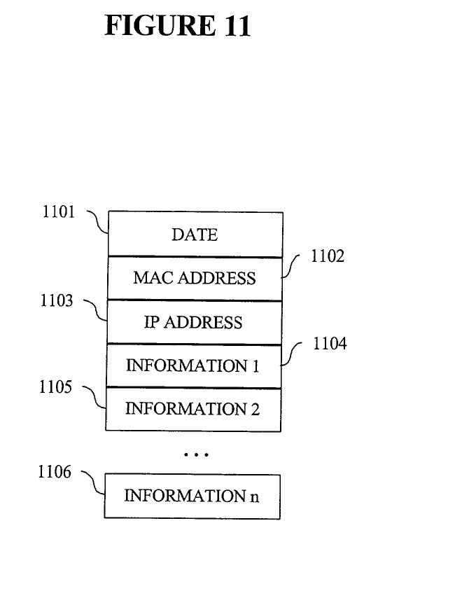

FIG. 11 is an exemplary data structure providing device status information that is stored in the databases 100, 112 according to one embodiment of the present invention. As shown in FIG. 11, the data structure includes, for example, a date field 1101, a MAC address field 1102, an IP address field 1103, and one or more information fields 1104, 1105, 1106 containing information of interest at the remote monitor workstation 111.

FIG. 12 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of the data structures/information shown in FIGS. 10 and 11, or any other data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. In preferred embodiments, the local network 1214 and the communications network 1216 preferably use electrical, electromagnetic, or optical signals that carry digital data streams. The signals through the various networks and the signals on the network link 1214 and through the communication interface 1213, which carry the digital data to and from the computer system 1201, are exemplary forms of carrier waves transporting the information. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA), laptop computer, or cellular telephone. The LAN communications network 1215 and the communications network 1216 both use electrical, electromagnetic or optical signals that carry digital data streams. The signals through the various networks and the signals on the network link 1214 and through the communication interface 1213, which carry the digital data to and from the system 1201, are exemplary forms of carrier waves transporting the information. The computer system 1201 can transmit notifications and receive data, including program code, through the network(s), the network link 1214 and the communication interface 1213.

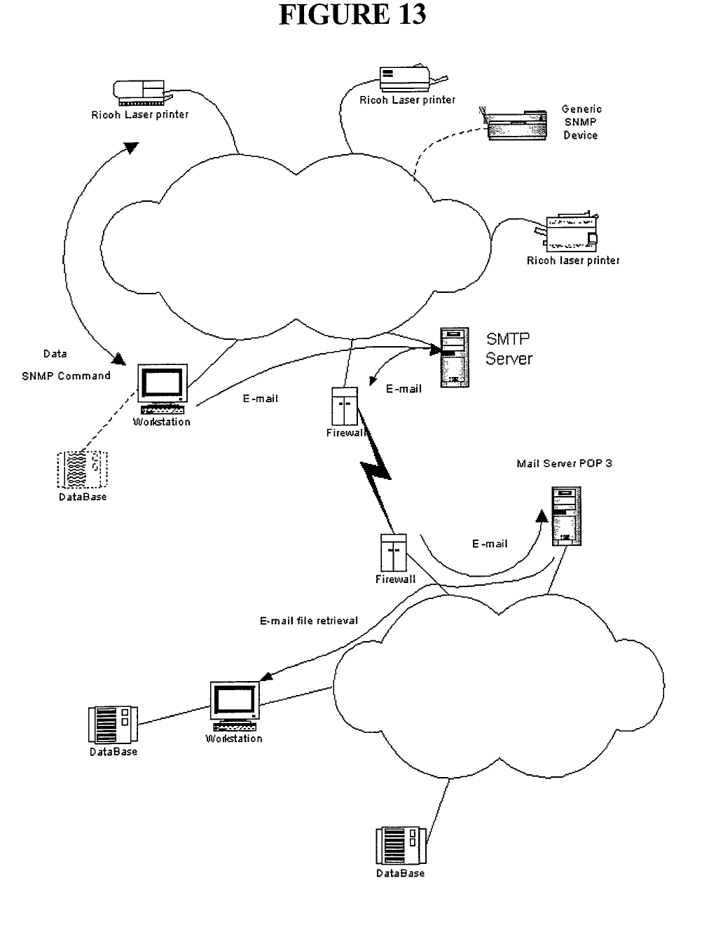

FIGS. 13-16 describe an exemplary architecture for one embodiment of the present invention. This exemplary architecture uses SNMP++ DLL, which is freely available from Hewlett Packard as the standard network management library 301. Using a freeware package such as SNMP++ reduces the amount of work required to access SNMP objects. As described above, any library supporting a standard network management protocol such as SNMP can be used. The descriptions of the various interfaces to POP 3, SMTP and ODBC may be obtained from the appropriate resources such as the Internet Engineering Task Force (IETF) and/or documentation available from the library vendors, such as Microsoft Corporation.

FIG. 13 is a block diagram showing the overall system configuration. As shown in FIG. 13, there are two subsystems in this exemplary architecture, one for sending the device information such as status and configuration information, and the other for receiving the device status information. The sending subsystem includes the workstation responsible for monitoring the various devices and sending the status and configuration information corresponding to the monitored devices. The receiving subsystem stores the information received from the sending subsystem into a database. Once the data are stored in the database, various services, such as support and remote maintenance of devices, become enabled.

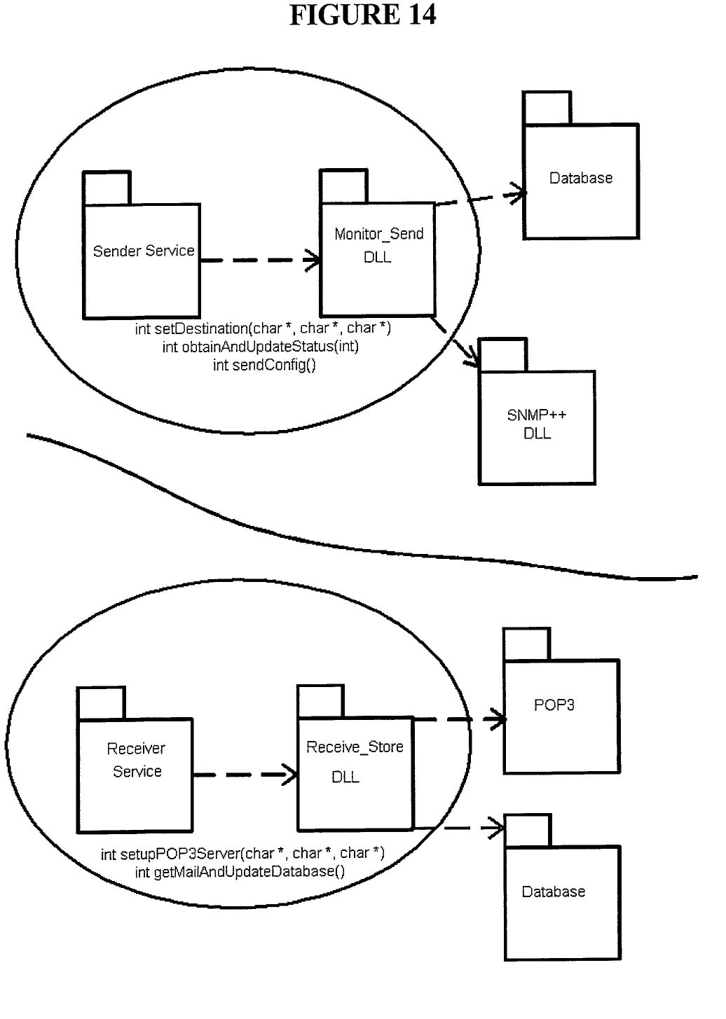

FIG. 14 shows the interactions among the major packages, as implemented in this exemplary architecture. SNMP ++ DLL contains various classes to assist the processing of SNMP commands. In this example, the database is ACCESS available from Microsoft Corporation. ODBC is chosen as a standard database interface, so that the system will not be bound to a particular database. The two circled components, Sending Subsystem and Receiving Subsystem, require custom development in this exemplary implementation. As shown in FIG. 14, this architecture has defined three interface functions between the Sender Service and the Monitor_Send DLL. Those interfaces are described below for this embodiment:

int setDestination(char * in_szSMTPServer, char * in_szFrom, char * in_szRcpt)

This function sets up the SMTP server (name or IP address), the sender e-mail address, and the mail recipient. The return value int is chosen to allow use of an enumerated data type to cover a wide range of condition reporting, a 0 indicating no error.

int obtainAndUpdateStatus(int)

This function triggers the Monitor_Send DLL package to send SNMP commands to obtain information from the devices being monitored. The parameter int is 1 when the data should be sent to the receiving subsystem, 0 otherwise. The return value int is chosen to allow use of an enumerated data type to cover a wide range of condition reporting, a 0 indicating no error.

int sendconfig(void)

This function triggers the configuration information to be sent to the receiving subsystem. Before sending the configuration information, the function obtains the MAC address for the corresponding IP address in the database. The return int is used to show the status of the function call. The return value int is chosen to allow use of an enumerated data type to cover a wide range of condition reporting, a 0 indicating no error.

int setupPOP3Server(char * in_szPOP3Server, char * in_szUserName, char * in_szPassword)

This function sets up the POP 3 server with a user name and password. The return value int is chosen to allow use of an enumerated data type to cover a wide range of condition reporting, a 0 indicating no error.

int getMailAndUpdateDatabase(void)

This function triggers the Receive_Store DLL package to access the POP 3 server, to get the received mails for processing, to delete those mails, to decode and decrypt mails, to parse mail data, and to store the received data into the database. The return value int is chosen to allow use of an enumerated data type to cover a wide range of condition reporting, a 0 indicating no error.

The Sender Service package is responsible for initializing the sending subsystem by using the setDestination() and sendconfig() functions to send the device information to the receiver. It is also responsible for installing the service and for starting up the service that periodically calls the obtainAndUpdateStatus() function. If the sending subsystem needs to send the status information to the receiving subsystem, the Sender Service sets the parameter passed in the obtainAndUpdateStatus function to ‘1,’ otherwise a ‘0’ is passed.

The Receiver Service package is responsible for initializing the receiving subsystem by using the setupPOP3Servero function. It is also responsible for installing the service and for starting up the service that periodically calls the getMailAndUpdateDatabase() function.

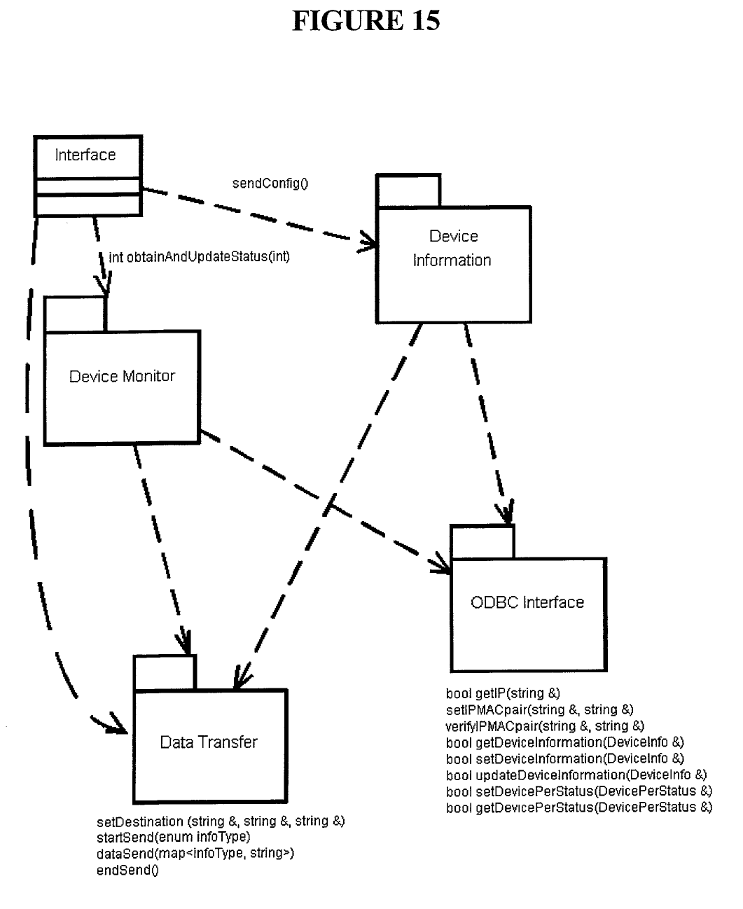

FIG. 15 shows an overview of Monitor_Send DLL package of this exemplary embodiment. The Monitor_Send DLL package is responsible for sending the device information to the receiving subsystem, and for sending SNMP commands to obtain the status information from the networked SNMP devices. The Monitor_Send DLL package is also responsible for sending the status information to the receiving subsystem when requested via the interface. The functions included in the Monitor_Send DLL package, as shown in FIG. 15, are described below:

int obtainAndUpdateStatus(int)

This function triggers the Device Monitor package to send SNMP commands to obtain information from the devices being monitored. The parameter int is 1 when the data should be sent to the receiving subsystem, 0 otherwise. The return value int is chosen to allow use of an enumerated data type to cover a wide range of condition reporting, a 0 indicating no error.

int sendConfig(void)

This function triggers the configuration information to be sent to the receiving subsystem. Before sending the configuration information, the function obtains the MAC address for the corresponding IP address from the database. The return int is used to show the status of the function call. The return value int is chosen to allow use of an enumerated data type to cover a wide range of condition reporting, a 0 indicating no error.

int setDestination(std::string & in_sSMTPServer, std::string & in_sfrom, std::string & in_sRcpt)

This function sets up the SMTP server (name or IP address), the sender e-mail address, and the mail recipient. The return value int is chosen to allow use of an enumerated data type to cover a wide range of condition reporting, a 0 indicating no error.

bool startSend(infoType)

This function initiates the SMTP starting sequence and the populates the data in the subject line, headers, MIME boundary separator, and data type line. The return boolean value is TRUE when the function is successful, and FALSE otherwise.

bool dataSend(map<infoType, std::string>&)

This function sends the contents of the map including the data start string. In one embodiment the map is a C++ template having two columns and multiple rows. The first column is a key and the second column contains a value corresponding to the key for that row. In this function, the map is sent. This function encrypts and encodes the data in base64. The return boolean value is TRUE when the function is successful, and FALSE otherwise.

bool endSend(void)

This function sends the data end string, MIME boundary separator, and end of mail string. It also closes the SMTP connection. The return boolean value is TRUE when the function is successful, and FALSE otherwise.

bool getIP(std::string &)

This function obtains the IP address of the networked SNMP devices. The return boolean value is TRUE if the returned IP address is valid, and FALSE if there is no matching IP address, or there are no more devices to report their IP address.

bool setIPMACpair(std::string & in_sIP, std::string & in_sMAC)

This function sets the MAC address for the corresponding IP address. The return boolean value is TRUE when the function is successful, and FALSE otherwise.

bool verifyIPMACpair(std::string & in sIP, std::string & in sMAC)

This function checks the MAC address against the IP address.

bool getDevicelnformation(Devicelnfo &)

This function returns the DeviceInfo structure. The Devicelnfo data structure is discussed below. The function returns a TRUE value when the returned data structure is valid, and a FALSE value when there no data structure is returned.

bool setDevicelnformation(Devicelnfo &)

This function sets the DeviceInfo structure. The return boolean value is TRUE when the function is successful, and FALSE otherwise.

bool updateDevicelnformation(Devicelnfo &)

This function updates the DeviceInfo structure for the given device identification (MAC address). The return boolean value is TRUE when the function is successful, and FALSE otherwise.

bool getDevicePerStatus(DevicePerStatus &)

This function gets the DevicePerStatus data structure. The DevicePerStatus data structure is discussed below. The function returns a TRUE value when the returned data structure is valid, and a FALSE value when no data structure is returned.

bool setDevicePerStatus(DevicePerStatus &)

This function sets the DevicePerStatus data structure. The return boolean value is TRUE when the function is successful, and FALSE otherwise.

Several of the functions described above are used to manipulate data structures. Those data structures for this exemplary embodiment of the present invention are described below:

DeviceInfo Data Structure

The Devicelnfo data structure reflects the information corresponding to a particular monitored device. The Devicelnfo data structure, as shown in Table 1.1 below, contains, among other data, the e-mail address of the contact person and their telephone number.

TABLE 1.1
DeviceInfo Data Structure

| Type | Name | Description |
|---|---|---|
| std::string | m_sManufacturer | A string representing the manufacturer |
| | | of the networked device. |
| std::string | m_sModel | A string representing the model of the |
| | | networked device. |
| std::string | m_sSerialNumber | A string representing the serial number |
| | | of the networked device. (May be |
| | | empty if the serial number is not |
| | | available). |
| std::string | m_sMACAddress | A string representing the MAC address |
| | | of the networked device. This informa- |
| | | tion may be obtained from the net- |
| | | worked device through SNMP and |
| | | added to the database. |
| std::string | m_sIPAddress | A string representing the IP address of |
| | | the networked device. |
| std::string | m_sCompanyName | A string representing the name of the |
| | | company which owns the networked |
| | | device. |
| std::string | m_sStreet | A string representing the street address |
| | | of the company. |
| std::string | m_sCity | A string representing the city where the |
| | | company is located. |
| std::string | m_sState | A string representing the state where the |
| | | company is located. |
| std::string | m_sZipCode | A string representing the zip code of the |
| | | company. |
| std::string | m_sLocation | A string representing the location of the |
| | | network printer within the company. |
| std::string | m_sContactPerson | A string representing the name of the |
| | | contact person responsible for the |
| | | networked device. |
| std::string | m_sPhoneNumber | A string representing the phone number |
| | | of the contact person. |
| std::string | m_sEMailAddress | A string representing the e-mail address |
| | | of the contact person. |

DevicePerStatus Data Structure

The DevicePerStatus data structure contains the data structure to be kept between the information transfer. In this exemplary embodiment of the present invention, as shown in Table 1.2 below, eight items are included in the data structure to capture various configuration and/or status information of the networked devices being monitored. These values in the DevicePerStatus data structure are set to a value of ‘1,’ indicating ON when the periodic SNMP monitoring detects the bit corresponding to the field, and, after sending the information, they are reset to a value of ‘0,’ indicating OFF.

TABLE 1.2
DevicePerStatus Data Structure

| Type | Name |
|---|---|
| std::string | m_sMACAddress |
| std::string | m_sIPAddress |
| Unsigned char | m_nLowPaper |
| Unsigned char | m_nNoPaper |
| Unsigned char | m_nLowToner |
| Unsigned char | m_nNoToner |
| Unsigned char | m_nDoorOpen |
| Unsigned char | m_nJammed |
| Unsigned char | m_nOffline |
| Unsigned char | m_nServiceRequested |

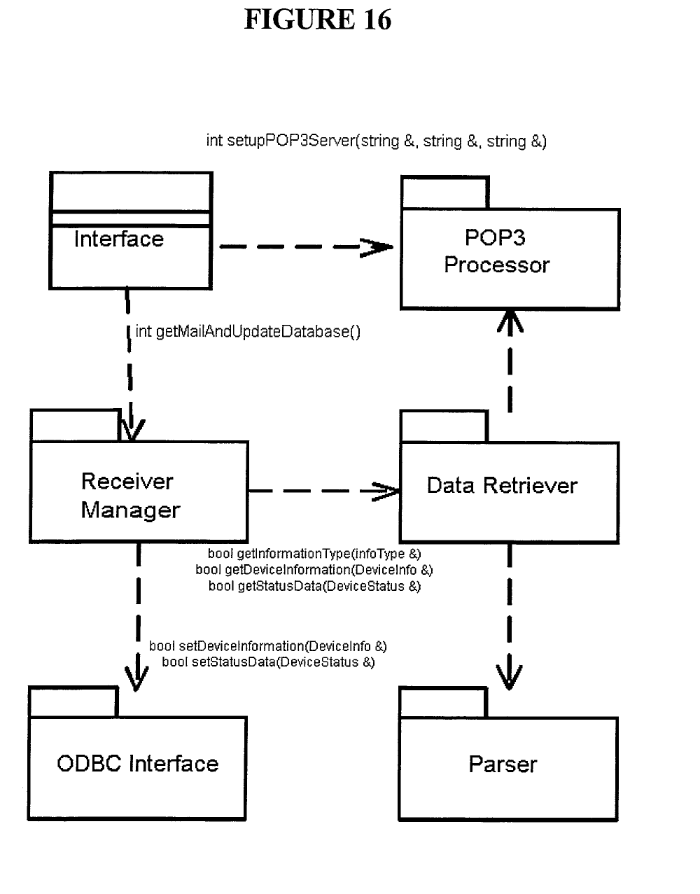

FIG. 16 shows an overview of the Receive_Store DLL package of this exemplary embodiment. The Receive_Store DLL package is responsible for retrieving and deleting the e-mails in the POP 3 server, for decoding the base64 data in the MIME attachment, for decrypting the data, for parsing the data, and for storing the data into the database. The functions included in the Receive_Store DLL package, as shown in FIG. 16, are described below:

int getMailAndUpdateDatabase(void)

This function triggers receiver 212 to access the POP 3 server, to get the received mails for processing, to delete those mails, to decode and decrypt mails, to parse mail data and to store the received data into the database. The return value int is chosen to allow use of an enumerated data type to cover a wide range of condition reporting, a 0 indicating no error.

bool getlnformationType(infoType &)

This function triggers the system to access the POP 3 server and to parse the first data type portion of the first mail. Note that there can be more than one mail in the POP 3 server. Therefore, the system shall iterate until the return value is FALSE. When there is a mail, the function returns a TRUE value, otherwise a FALSE value is returned. When the function returns FALSE, the infoType value shall be NotDefine.

bool getDevicelnformation(Devicelnfo &)

This function returns the Devicelnfo structure. The Devicelnfo data structure is discussed below. The function returns a TRUE value when the returned data structure is valid, and a FALSE value when there no data structure is returned.

bool setDevicelnformation(Devicelnfo &)

This function sets the Devicelnfo structure. The return boolean value is TRUE when the function is successful, and FALSE otherwise.

bool getStatusData(DeviceStatus &)

This function retrieves the DeviceStatus data structure. The function returns a TRUE value when the returned data structure is valid, and a FALSE value when no data structure is returned.

bool setStatusData(DeviceStatus &)

This function passes the DeviceStatus data structure and sets the historical data in the database. The return boolean value is TRUE when the function is successful, and FALSE otherwise.

int setupPOP3Server(std::string & in_sPOP3Server, std::string & in_sUserName, std::string & in_sPassword)

This function sets up the POP 3 server with a user name and password. The return value int is chosen to allow use of an enumerated data type to cover a wide range of condition reporting, a 0 indicating no error.

Several of the functions described above are used to manipulate the DeviceStatus data structure. This data structure for this exemplary embodiment of the present invention is described below:

DeviceStatus Data Structure

The DeviceStatus data structure, as shown in Table 1.3, contains all the items to be kept in the historical database. The device identification (MAC address) is used to relate the historical data to the device information.

TABLE 1.3
DeviceStatus Data Structure

| Type | Name |
|---|---|
| CTime | m_Time |
| std::string | m_sMACAddress |
| std::string | m_sIPAddress |
| unsigned int | m_nSysUpTime |
| unsigned int | m_nHrDeviceErrors |
| int | m_nPrinterStatus |
| unsigned char | m_nLowPaper |
| unsigned char | m_nNoPaper |
| unsigned char | m_nLowToner |
| unsigned char | m_nNoToner |
| unsigned char | m_nDoorOpen |
| unsigned char | m_nJammed |
| unsigned char | m_nOffline |
| unsigned char | m_nServiceRequested |
| unsigned int | m_nPrtGeneralConfigChanges |
| unsigned int | m_nPrtLifeCount |
| int | m_nPrtMarkerSuppliesLevel1 |
| int | m_nPrtMarkerSuppliesLevel2 |
| int | m_nPrtMarkerSuppliesLevel3 |
| int | m_nPrtMarkerSuppliesLevel4 |

Obviously, numerous modifications and variations of the present invention are possible in light of the above teachings. It is therefore to be understood that within the scope of the appended claims, the invention may be practiced otherwise than as specifically described herein.

1. A computer-implemented remote device monitoring system, comprising:
a processor; and
a computer readable medium encoded with processor readable instructions that when executed by the processor implement,
a device information collecting mechanism configured to collect information from a device connected to a first network using a network management protocol;
a device information sending mechanism configured to send the information to a monitor connected to a second network via a wide area network using a protocol; and
a device information receiving mechanism configured to receive the information using the protocol and store the information in a digital repository connected to the second network.

2. The system of claim 1, wherein the information comprises at least one of status information corresponding to the device and configuration information corresponding to the device.

3. The system of claim 2, wherein the device comprises a printer.

4. The system of claim 2, wherein status information comprises at least one of a low paper indicator, a no paper indicator, a low toner indicator, a no toner indicator, door open indicator, a jammed indicator, an offline indicator, and a service requested indicator.

5. The system of claim 2, wherein configuration information comprises at least one of a manufacturer of the device, a model of the device, a serial number of the device, a media access control address, an Internet protocol address, a company name, a street address, a city, a state, a postal code, a physical location of the device, a contact person for the device, a phone number for the contact person, and an e-mail address for the contact person.

6. The system of claim 1, wherein at least a portion of the wide area network comprises the Internet.

7. The system of claim 1, wherein the protocol comprises at least one of a simple mail transfer protocol and an Internet mail access protocol.

8. The system of claim 1, wherein at least a portion of at least one of the first network and the second network comprises an intranet.

9. The system of claim 1, wherein the digital repository comprises a database.

10. The system of claim 1, wherein:
the computer readable medium is further encoded with processor readable instructions that when executed by the processor further implements,
a device information storing mechanism configured to store the information collected by the device information collecting mechanism in a first digital repository connected to the first network; and
the device information sending mechanism is further configured to retrieve the information from the first digital repository.

11. The system of claim 10, wherein the digital repository comprises a database.

12. The system of claim 1, wherein the processor readable instructions comprises at least one of a dynamic link library, a static link library, a script, a JAVA class, a C++ class, and a C library routine.

13. The system of claim 1, wherein the network management protocol comprises a simple network management protocol.

14. The system of claim 1, wherein the device information receiving mechanism is further configured to store the information in the digital repository through an open database connectivity interface.

15. The system of claim 10, wherein the device information storing mechanism is further configured to store the information in the first digital repository through an open database connectivity interface.

16. A method for remotely monitoring network devices, comprising the steps of:
collecting information from a device connected to a first network using a network management protocol;
sending the information collected in the collecting step to a monitor connected to a second network via a wide area network using a protocol;
receiving the information sent in the sending step by the monitor; and
storing the information received in the receiving step in a digital repository connected to the second network.

17. The method of claim 16, wherein the information comprises at least one of status information corresponding to the device and configuration information corresponding to the device.

18. The method of claim 16, wherein the device comprises a printer.

19. The method of claim 16, wherein at least a portion of the wide area network comprises the Internet.

20. The method of claim 16, wherein the network management protocol comprises a simple network management protocol.

21. The method of claim 16, wherein the protocol comprises at least one of a simple mail transfer protocol and an Internet access protocol.

22. The method of claim 16, wherein the digital repository comprises a database.

23. The method of claim 16, further comprising the steps of:
storing the collected information collected in the in the collecting step in a first digital repository; and
retrieving the information stored in the storing the collected information step from the first digital repository.

24. The method of claim 23, wherein the first digital repository comprises a database.

25. A computer program product, comprising:
a computer storage medium; and
a computer program code mechanism embedded in the computer storage medium for causing a computer to remotely monitor a device connected to a first network with a monitor connected to a second network, the computer program code mechanism having,
a first computer code device configured to collect information from the device using a network management protocol,
a second computer code device configured to send the information to the monitor via a wide area network using a protocol,
a third computer code device configured to receive the information sent to the monitor; and
a fourth computer code device configured to store the information received in a digital repository connected to the second network.

26. The computer program product of claim 25, wherein the information comprises at least one of status information corresponding to the device and configuration information corresponding to the device.

27. The computer program product of claim 25, wherein the device comprises a printer.

28. The computer program product of claim 25, wherein at least a portion of the wide area network comprises the Internet.

29. The computer program product of claim 25, wherein the network management protocol comprises a simple network management protocol.

30. The computer program product of claim 25, wherein the protocol comprises at least one of a simple mail transfer protocol and an Internet access protocol.

31. The computer program product of claim 25, wherein the digital repository comprises a database.

32. The computer program product of claim 25, wherein the computer program code mechanism further having,
a fifth computer code device configured to store the information collected by the first computer code device in a first digital repository, and
a sixth computer code device configured to retrieve the information from the first digital repository.

33. The computer program product of claim 32, wherein the first digital repository comprises a database.

34. A system for remotely monitoring network devices, comprising:
means for collecting information from a device connected to a first network using a network management protocol;
means for sending the information collected in the collecting step to a monitor connected to a second network via a wide area network using a protocol;
means for receiving the information sent in the sending step by the monitor; and
means for storing the information received in the receiving step in a digital repository connected to the second network.

35. The system of claim 34, wherein:
the network management protocol is a simple network management protocol; and
the protocol is at least one of a simple mail transfer protocol and an Internet mail access protocol.
